(19) United States
(12) Patent Application Publication
(10) Pub. No.: US 2025/0310241 A1
(43) Pub. Date: Oct. 2, 2025

(54) COMMUNICATION SYSTEM, COMMUNICATION METHOD, AND NON-TRANSITORY COMPUTER READABLE MEDIUM

(71) Applicant: Mitsubishi Electric Corporation, Tokyo (JP)

(72) Inventors: Hiroyuki ICHII, Tokyo (JP); Takenori SUMI, Tokyo (JP); Yasushi MATSUTAKA, Tokyo (JP); Yusuke TAKIGAWA, Tokyo (JP); Koki KURISU, Tokyo (JP); Daigo ADACHI, Tokyo (JP)

(73) Assignee: Mitsubishi Electric Corporation, Tokyo (JP)

(21) Appl. No.: 19/240,905

(22) Filed: Jun. 17, 2025

Related U.S. Application Data
(63) Continuation of application No. PCT/JP2023/004760, filed on Feb. 13, 2023.

(51) Int. Cl. H04L 45/00; H04W 40/12

(52) U.S. Cl. CPC H04L 45/20; H04W 40/12

(57) ABSTRACT

A target node, which is a node (2) included in a communication system that includes a sink node and a plurality of nodes (2) and is capable of constructing a multi-hop wireless communication network, includes a communication control unit (22) and a transmission and reception unit (21). Upon receiving transfer data that is transmitted from a source node, which is a node (2), to the sink node and indicates an update value corresponding to a hop count from the source node to the target node, the communication control unit (22) updates a first update value, which is the update value indicated by the received transfer data, to an updated first update value. If the updated first update value has not reached a transfer end value, the transmission and reception unit (21) transmits the transfer data in which the first update value has been updated to the updated first update value to surroundings of the target node. A difference between the first update value and the updated first update value corresponds to one hop, and an initial value of the update value indicated by the transfer data is a value corresponding to a hop count from the source node to the sink node.

### CROSS REFERENCE TO RELATED APPLICATION

This application is a Continuation of PCT International Application No. PCT/JP2023/004760, filed on Feb. 13, 2023, which is hereby expressly incorporated by reference into the present application.

### TECHNICAL FIELD

The present disclosure relates to a communication system, a communication method, and a communication program.

### BACKGROUND ART

Non-Patent Literature 1 discloses a transfer method called flooding. In flooding, upon receiving data, each node transfers the data to other nodes that are present within a communication range of each node. As the data is transferred repeatedly, the data ultimately reaches its destination node. In this case, parameters used in transfer control of flooding include the number of times to transmit data from each node, the number of times to transmit data transferred by each node, and a maximum hop count when data is transferred. Normally, data is transferred by a plurality of nodes. Therefore, even if the data is lost between some nodes, the data will reach a destination node, provided that another node has received the data.

### CITATION LIST

### Non-Patent Literature

Non-Patent Literature 1: “Mesh Profile”, Bluetooth SIG, 2019, v1.0.1, pp. 18-19

### SUMMARY OF INVENTION

### Technical Problem

In conventional flooding, the number of times to transmit data from each node, the number of times to transmit data transferred by each node, the maximum hop count when data is transferred, and so on are pre-set parameters, and these parameter values are uniformly set for all nodes according to the scale of a network. However, a problem is that depending on the configuration or scale of a network, data cannot be efficiently transferred unless appropriate parameter values are set for each node, resulting in a decrease in transfer efficiency in the entire network.

An object of the present disclosure is to improve, in a multi-hop wireless communication network, transfer efficiency in the entire network by transferring data efficiently by each node.

### Solution to Problem

A communication system according to the present disclosure includes a sink node and a plurality of nodes, and the communication system is capable of constructing a multi-hop wireless communication network,
wherein a target node, which is each node of the plurality of nodes, includes:
   a communication control unit to update a first update value to an updated first update value upon receiving transfer data that is transmitted from a source node included in the plurality of nodes to the sink node and indicates an update value corresponding to a hop count from the source node to the target node, the first update value being the update value indicated by the received transfer data; and
   a transmission and reception unit to transmit transfer data in which the first update value has been updated to the updated first update value to surroundings of the target node when the updated first update value has not reached a transfer end value,
wherein a difference between the first update value and the updated first update value corresponds to one hop, and
wherein an initial value of the update value indicated by the transfer data is a value corresponding to a hop count from the source node to the sink node.

### Advantageous Effects of Invention

According to the present disclosure, a communication control unit of a target node included in a communication system capable of constructing a multi-hop wireless communication network updates a first update value, which is an update value indicated by received transfer data, to an updated first update value. Then, if the updated first update value has not reached a transmission end value, a transmission and reception unit of the target node transmits the transfer data in which the first update value has been updated to the updated first update value to the surroundings of the target node. A difference between the first update value and the updated first update value corresponds to one hop, and an initial value of the update value indicated by the transfer data is a value corresponding to a hop count from a source node to a sink node. Thus, according to the present disclosure, the maximum number of times to transfer the transfer data is a value corresponding to the hop count from the source node to the sink node.

Therefore, according to the present disclosure, it is possible in a multi-hop wireless communication network to improve transmission efficiency of the entire network by transferring data efficiently by each node.

### BRIEF DESCRIPTION OF DRAWINGS

FIG. 1 is a diagram illustrating an example of the configuration of a communication system 5 according to Embodiment 1.

FIG. 2 is a diagram illustrating a structure of transfer data 150 according to Embodiment 1.

FIG. 3 is a diagram illustrating an example of the functional configuration of a sink node 1 according to Embodiment 1.

FIG. 4 is a diagram illustrating an example of the functional configuration of a node 2 according to Embodiment 1.

FIG. 5 is a diagram illustrating an example of the hardware configuration of the sink node 1 according to Embodiment 1.

FIG. 6 is a diagram describing the operation of the communication system 5 according to conventional technology.

FIG. 7 is a flowchart illustrating a procedure for setting an initial value I according to Embodiment 1.

FIG. 8 is a sequence diagram illustrating a procedure for generating hop count information 160 according to Embodiment 1.

FIG. 9 is a diagram describing transmission and reception of a transfer hop count signal according to Embodiment 1.

FIG. 10 is a diagram illustrating the hop count information 160 according to Embodiment 1.

FIG. 11 is a flowchart illustrating a procedure for setting the initial value I according to Embodiment 1.

FIG. 12 is a diagram illustrating an example of the hardware configuration of the sink node 1 according to a variation of Embodiment 1.

FIG. 13 is a sequence diagram illustrating a procedure for setting the number of times to transmit according to Embodiment 2.

FIG. 14 is a flowchart illustrating a procedure for setting the number of times to transmit according to Embodiment 2.

FIG. 15 is a sequence diagram illustrating a procedure for setting a transfer function according to Embodiment 3.

FIG. 16 is a flowchart illustrating the procedure for setting the transfer function according to Embodiment 3.

FIG. 17 is a diagram illustrating an example of the configuration of a communication system 6 according to Embodiment 4.

FIG. 18 is a sequence diagram illustrating a procedure for setting a transfer function according to Embodiment 4.

FIG. 19 is a sequence diagram illustrating the procedure for setting the transfer function according to Embodiment 4.

FIG. 20 is a sequence diagram illustrating the procedure for setting the transfer function according to Embodiment 4.

FIG. 21 is a diagram illustrating a data structure of a message transmission instruction according to Embodiment 4.

FIG. 22 is a diagram illustrating a data structure of a measurement result notification according to Embodiment 4.

FIG. 23 is a flowchart illustrating aggregation processing according to Embodiment 4.

FIG. 24 is a diagram describing an example of selection of a transfer node according to Embodiment 4.

### DESCRIPTION OF EMBODIMENTS

In the description and drawings of embodiments, the same reference numerals are assigned to the same elements and corresponding elements. The description of elements with the same reference numerals is appropriately omitted or simplified. Arrows in diagrams mainly indicate flows of data or flows of processing. “Unit” may be appropriately interpreted as “circuit”, “step”, “procedure”, “process”, or “circuitry”.

### Embodiment 1

This embodiment will be described in detail below with reference to the drawings.

An object of Embodiment 1 is to improve transfer efficiency of data transmitted from each node 2 to a sink node 1.

### *** Description of Configuration ***

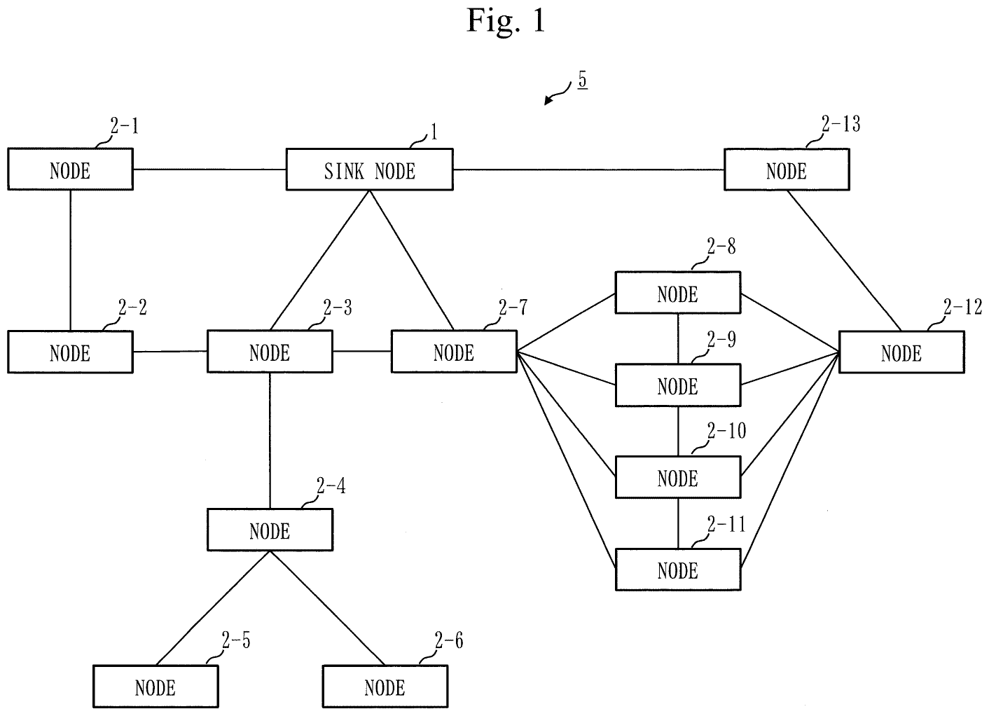

FIG. 1 is a diagram illustrating an example of the configuration of a communication system 5 according to Embodiment 1. The communication system 5 includes the sink node 1, which is an example of a sink node, and a plurality of nodes 2. In FIG. 1, the communication system 5 includes the sink node 1 and nodes 2-1 to 2-13, which are an example of the plurality of nodes 2. The communication system 5 can construct a multi-hop wireless communication network.

Although one sink node 1 and 13 nodes 2 are illustrated in FIG. 1, the number of sink nodes 1 and the number of nodes 2 are not limited to the examples shown in FIG. 1. Hereafter, when each of the plurality of nodes 2 is indicated without distinguishing them individually, it is referred to as the “node 2”. The sink node 1 and the nodes 2 may be collectively referred to as the “node”.

The sink node 1 and each node 2 transmit and receive data (also called a signal or information in this specification) to and from each other. In particular, each node 2 frequently transmits data to the sink node 1.

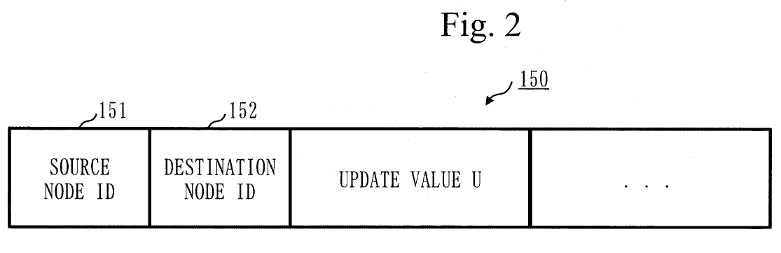

FIG. 2 is a diagram illustrating a structure of transfer data 150 according to Embodiment 1. The transfer data 150 is data that is transmitted from each node 2 to the sink node 1, is transmitted and received in each node 2, and indicates a source node identification (ID) 151, a destination node ID 152, and an update value U.

The source node ID 151 is an ID indicating a source node, which is a source from which the transfer data 150 is transmitted. IDs are symbols used to identify the sink node 1 and each node 2.

The destination node ID 152 is an ID indicating a destination node, which is a destination of the transfer data 150.

The update value U is an update value of an upper limit of a hop count and is a value indicating the maximum number of remaining hops allowed for the transfer data 150 being transferred. The value of U is the same as an initial value I at the time point when the source node transmits the transfer data 150, and is decremented by one each time the sink node 1 or the node 2 that has received the transfer data 150 (hereinafter, also simply referred to as a receiving node) transfers the transfer data 150. The initial value I indicates the initial value of the update value U, and indicates the upper limit of the hop count. The transfer data 150 is allowed a maximum of I hops from the source node.

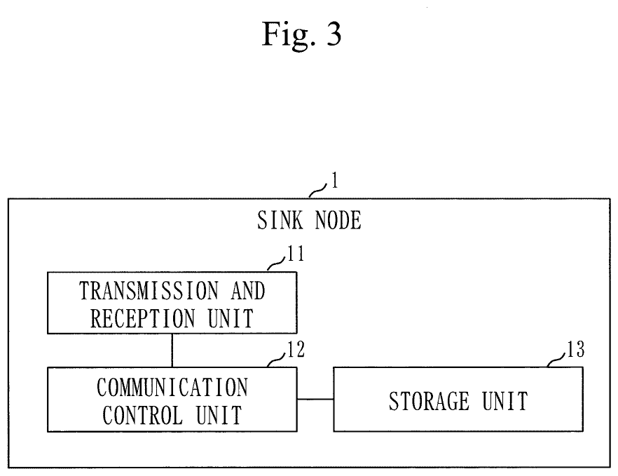

FIG. 3 is a diagram illustrating an example of the functional configuration of the sink node 1. The sink node 1 includes a transmission and reception unit 11, a communication control unit 12 and a storage unit 13.

The transmission and reception unit 11 communicates data with each node 2. Upon receiving a signal from the node 2, the transmission and reception unit 11 outputs the received signal to the communication control unit 12. The transmission and reception unit 11 also transmits the signal to the node 2 based on an instruction from the communication control unit 12.

Upon receiving a signal from the transmission and reception unit 11, the communication control unit 12 performs predetermined processing based on the received signal.

The storage unit 13 appropriately stores data necessary for realizing the functions of the communication system 5.

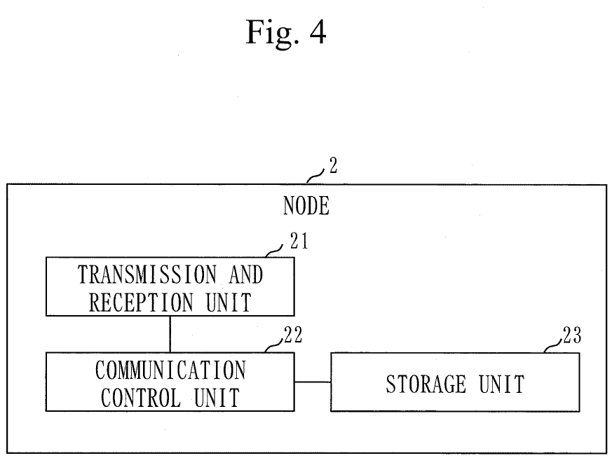

FIG. 4 is a diagram illustrating an example of the functional configuration of the node 2. The node 2 includes a transmission and reception unit 21, a communication control unit 22, and a storage unit 23.

The transmission and reception unit 21 communicates data with the sink node 1 or the node 2, each of which is another node in the multi-hop wireless communication network. Upon receiving a signal from another node, the transmission and reception unit 21 outputs the received signal to the communication control unit 22. The transmission and reception unit 21 also transmits the signal to another node based on an instruction from the communication control unit 22.

If an updated first update value to be described later has not reached a transfer end value, the transmission and reception unit 21 of a target node, where the target node is each node 2 of the plurality of nodes 2, transmits the transfer data 150 in which a first update value to be described later has been updated to the updated first update value to the surroundings of the target node. As a specific example, the transfer end value is 0. A difference between the first update value and the updated first update value corresponds to one hop. The initial value I, which is the initial value of the update value U indicated by the transfer data 150, corresponds to the hop count from the source node to the sink node 1.

If an updated second update value to be described later has not reached the transfer end value, the transmission and reception unit 21 of the target node transmits a transfer hop count signal in which a second update value to be described later has been updated to the updated second update value to the surroundings of the target node.

Upon receiving a signal from the transmission and reception unit 21, the communication control unit 22 performs predetermined processing based on the received signal.

Upon receiving the transfer data 150, the communication control unit 22 of the target node updates the first update value, which is the update value U indicated by the received transfer data 150, to the updated first update value. The transfer data 150 is data that is transmitted from the source node included in the plurality of nodes 2 to the sink node 1 and indicates the update value U. The update value U is a value that corresponds to the hop count from the source node to the target node.

When the target node receives the transfer hop count signal, the communication control unit 22 of the target node calculates a hop count from the target node to the sink node 1 based on the second update value and the initial value that are indicated by the received transfer hop count signal, stores the calculated hop count as a minimum hop count from the target node to the sink node 1, and updates the second update value indicated by the received transfer hop count signal to the updated second update value. The transfer hop count signal is a signal that is transmitted from the sink node 1 and indicates the second update value, which is the update value corresponding to the hop count from the sink node 1 to the target node, and the initial value of the second update value. A difference between the second update value and the updated second update value corresponds to one hop. The minimum hop count is used as an initial value of an update value indicated by first transmission data when the target node transmits the first transmission data to the sink node 1. If the transfer hop count signal has reached the target node through a plurality of routes, the communication control unit 22 of the target node may store, as the minimum hop count, a hop count corresponding to the shortest route among each route whose reception strength is equal to or greater than a first reference reception strength among the plurality of routes. That is, the minimum hop count that the target node stores is not limited to the actual minimum hop count from the sink node 1 to the target node, and may be a hop count corresponding to the shortest route among routes that can transfer data from the sink node 1 to the target node or from the target node to the sink node 1. The first reference reception strength may be specified in any way.

The communication control unit 22 of the target node may treat only each node 2 whose corresponding reception strength is equal to or greater than a second reference reception strength among the plurality of nodes 2 as a valid node 2. That is, the communication control unit 22 of the target node may disregard the node 2 whose corresponding reception strength is less than the second reference reception strength. The second reference reception strength may be specified in any way.

The storage unit 23 appropriately stores data necessary for realizing the functions of the communication system 5.

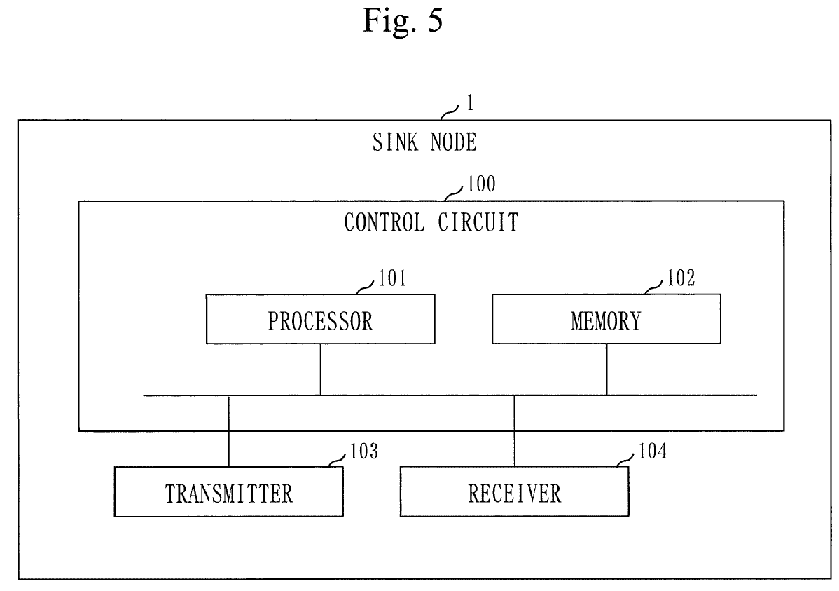

FIG. 5 is a diagram illustrating an example of the hardware configuration of the sink node 1. The sink node 1 includes a control circuit 100, a transmitter 103, and a receiver 104.

The control circuit 100 includes a processor 101 and a memory 102.

The processor 101 is a processing circuit, such as a central processing unit (CPU) or a digital signal processor (DSP), that performs arithmetic operations. The control circuit 100 may include a plurality of processors as an alternative to the processor 101. The plurality of processors share the role of the processor 101.

The memory 102 is a storage device composed of a random access memory (RAM), a read only memory (ROM), and so on.

The functions of each unit included in the sink node 1 are realized by execution of a communication program, which is stored in the memory 102, for realizing the operation of the sink node 1 in the processor 101. The functions of each unit of the sink node 1 are realized by software. The communication program may be recorded on a non-volatile computer readable recording medium. The non-volatile recording medium is, as a specific example, an optical disc or a flash memory. The communication program may be provided as a program product.

The storage unit 13 is realized by the memory 102.

The transmitter 103 is a device to transmit data to the surroundings.

The receiver 104 is a device to receive data from the surroundings. The transmission and reception unit 11 is realized by the transmitter 103 and the receiver 104.

The hardware configuration of the node 2 is substantially the same as the hardware configuration of the sink node 1, and thus description of the hardware configuration of the node 2 is omitted.

### *** Description of Operation ***

A procedure for the operation of the communication system 5 is equivalent to a communication method. A program that realizes the operation of the communication system 5 is equivalent to the communication program.

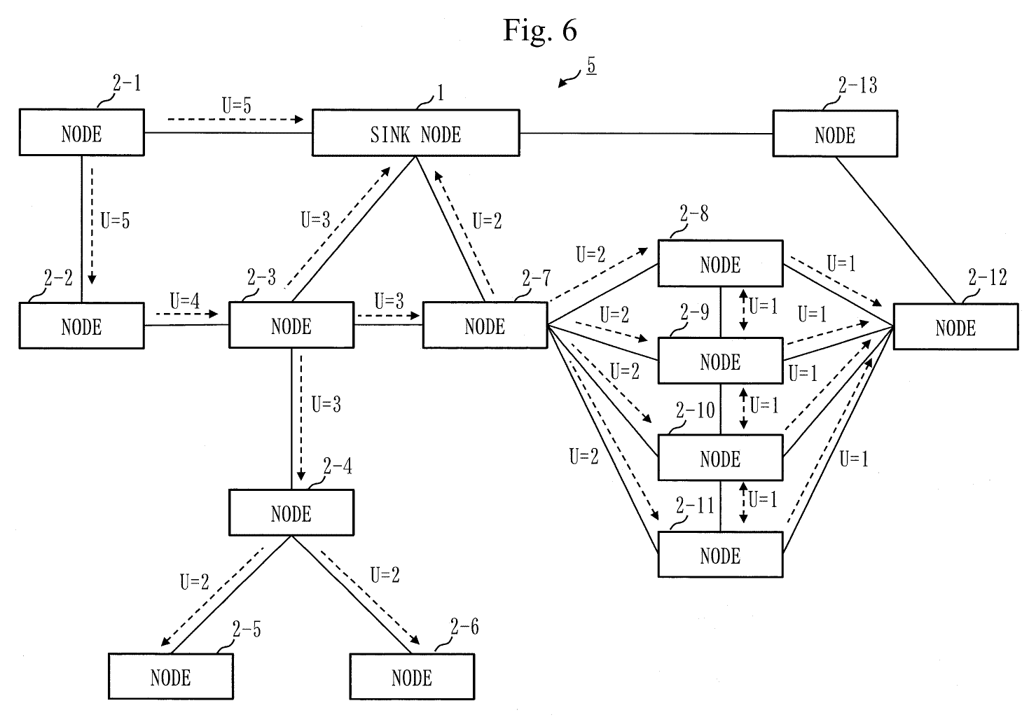

FIG. 6 illustrates an example of processing to transmit the transfer data 150 to the sink node 1 in the communication system 5 according to conventional technology. FIG. 6 illustrates transfer routes of data in a case where the data is transmitted from the node 2-1 to the sink node 1. The transfer data 150 indicates the source node ID 151, the destination node ID 152, the initial value I, and the update value U, as described above. In this example, the source node ID 151 indicates the ID of the node 2-1, and the destination node ID 152 indicates the ID of the sink node 1.

Based on the destination node ID 152 and the update value U indicated by the transfer data 150 received from another node, each receiving node determines whether or not to transfer the received transfer data 150. Specifically, if the destination node ID 152 indicates each receiving node itself, each receiving node does not transfer the transfer data 150 because transfer is not necessary. If a result of decrementing the update value U by one has reached 0 or a specified value, each receiving node does not transfer the transfer data 150 because any further transfer is not allowed.

In the example shown in FIG. 6, when the sink node 1 receives the transfer data 150, it does not transfer target data because the destination node ID 152 of the transfer data 150 indicates that the sink node 1 is the destination.

In the example shown in FIG. 6, the initial value I is 5, each arrow represents transfer of the transfer data 150, and the update value U at the time point corresponding to each arrow is indicated for each arrow. As a specific example, the update value U of the transfer data 150 transferred to the node 2-12 is 1. Therefore, the node 2-12 determines that a result of decrementing the update value U by one reaches 0 and thus does not transfer the transfer data 150. That is, in the example shown in FIG. 6, the maximum number of hops is limited to five times. Note that the update value U indicated by the transfer data 150 received by the node 2-12 corresponds to the first update value, and the result of decrementing the update value U by one corresponds to the updated first update value. Therefore, a difference between the first update value and the updated first update value corresponds to one hop.

No transfer routes are specified in the communication system 5. Therefore, even when the transfer data 150 indicates the node 2-1 as the source node and the sink node 1 as the destination node, the transfer route may randomly vary each time an attempt is made to transmit the transfer data 150. As a specific example, since the reception strength may vary with each attempt and there may be a node 2 that is not capable of reception (or capable of reception, conversely) at each attempt, whether or not a transfer route is formed may vary depending on whether or not the transfer data 150 can be received. Since the latency of each transfer route may vary with each attempt, a node that can start transfer first between adjacent nodes may vary with each attempt. As a result, a transfer direction may also vary with each attempt.

In a conventional multi-hop wireless communication network using flooding, the initial value I is uniformly set for each node 2 according to the size of the network. For this reason, when data is transmitted from the node 2 to a destination node with a relatively small minimum hop count from the node 2, unnecessary transfer may occur, such as transfer using a route via the node 2-7 as in the example shown in FIG. 6.

On the other hand, in this embodiment, in order to improve the transfer efficiency to the destination node, each node 2 holds hop count information 160 corresponding to each node 2, uses the hop count information 160 to appropriately set the initial value I when the transfer data 150 whose destination is the sink node 1 is to be transmitted, and then transmits the transfer data 150. The hop count information 160 corresponding to each node 2 is information indicating a hop count from each node 2 itself to each sink node 1. Therefore, according to this embodiment, it is possible to improve the transfer efficiency of the transfer data 150 whose destination is the sink node 1.

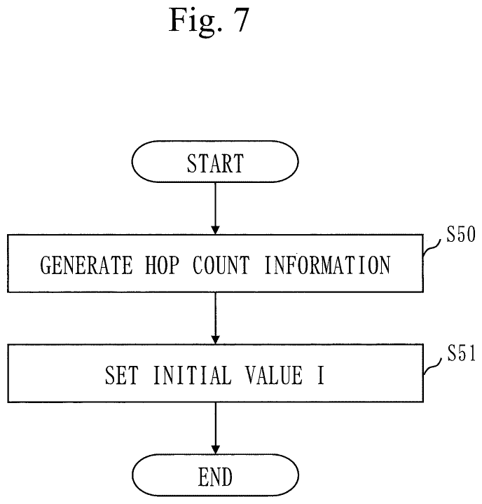

FIG. 7 is a flowchart illustrating an example of a procedure for setting the initial value I in each node 2. Using FIG. 7, the procedure for setting the initial value I will be described. It is assumed hereafter that there is one sink node 1 in the communication system 5. When there are a plurality of sink nodes 1 in the communication system 5, the following processing is performed for each sink node 1.

### (Step S50)

The communication control unit 22 generates the hop count information 160 and proceeds to step S51. The hop count information 160 is information that lists the minimum number of hops to reach the sink node 1 from the node 2 where the hop count information 160 is generated. Hereafter, the minimum number of hops to the sink node 1 from the node 2 where the hop count information 160 is generated will also be simply called a hop count to the sink node 1. There may be a plurality of routes from a certain node 2 to a certain sink node 1. Specifically, there may be a plurality of routes in transmission of one piece of the transfer data 150, and the route may vary when an attempt is made to transmit a new piece of the transfer data 150, as described above. In addition, the number of nodes may not be the same between routes. Therefore, the hop count information 160 is basically information that lists and retains a plurality of hop counts. Details of a procedure for generating the hop count information 160 will be described later.

### (Step S51)

The communication control unit 22 selects one hop count corresponding to the sink node 1 from the hop counts indicated by the hop count information 160 generated as the hop counts for the sink node 1, and when subsequently transmitting the transfer data 150 to the sink node 1, sets the selected hop count as the initial value I for the transfer data 150. Details of how to set the initial value I will be described later.

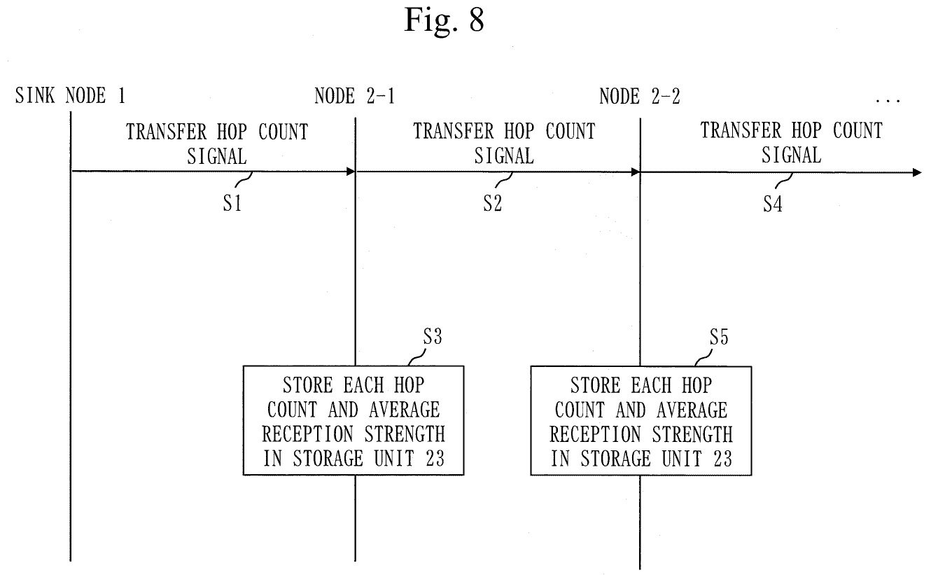

FIG. 8 is a sequence diagram illustrating an example of the procedure for generating the hop count information 160 in the communication system 5. Using FIG. 8, the procedure for generating the hop count information 160 will be described.

### (Step S1)

The sink node 1 transmits a transfer hop count signal, which is a signal for generating the hop count information 160.

Specifically, the communication control unit 12 generates the transfer hop count signal, and transmits the generated transfer hop count signal through the transmission and reception unit 11 to a group address or a unicast address. The transfer hop count signal contains the ID of the sink node 1 as the source node ID 151, the initial value I, and the update value U. At the time point when the sink node 1 transmits the transfer hop count signal, the initial value I and the update value U are the same value.

### (Step S2)

Upon receiving the transfer hop count signal, the node 2-1 decrements the update value U indicated by the received transfer hop count signal by one and then transfers the received transfer hop count signal.

Specifically, upon receiving the transfer hop count signal, the transmission and reception unit 21 first outputs the received transfer hop count signal to the communication control unit 22.

Next, the communication control unit 22 updates the update value U indicated by the transfer hop count signal received from the transmission and reception unit 21 to a value obtained by decrementing the update value U by one.

Next, the communication control unit 22 outputs the signal in which the update value U has been updated to the transmission and reception unit 21.

Next, the transmission and reception unit 21 transfers the signal received from the communication control unit 22 as the transfer hop count signal.

### (Step S3)

Upon receiving the transfer hop count signal, the node 2-1 stores data indicating a hop count to the sink node 1 and an average reception strength for each hop count in the storage unit 23. The transfer hop count signal may reach the node 2-1 through a plurality of routes. If the transfer hop count signal reaches the node 2-1 through a plurality of routes, the node 2-1 stores data corresponding to each route of the plurality of routes in the storage unit 23. The average reception strength at a certain hop count in the target node is an average value calculated when the target node has received a target signal through routes corresponding to this certain hop count a plurality of times, and is the average value of reception strengths of the target signal in the target node.

Specifically, the communication control unit 22 first calculates the hop count from the node 2-1 to the sink node 1 using the initial value I and the update value U indicated by the transfer hop count signal received from the transmission and reception unit 21. The hop count from the node 2 to the sink node 1 is a value calculated by I−U+1 [Formula 1].

Next, the communication control unit 22 stores data indicating the calculated hop count and the average reception strength for each hop count as the hop count information 160 in the storage unit 23. The hop count information 160 is information associating the hop count and the average reception strength corresponding to the hop count.

Step S4 is substantially the same as step S2 and thus description is omitted.

Step S5 is substantially the same as step S3 and thus description is omitted.

Then, although not illustrated in the figure, processing substantially the same as step S4 and step S5 is performed in each node 2 that has received the transfer hop count signal transferred from another node 2.

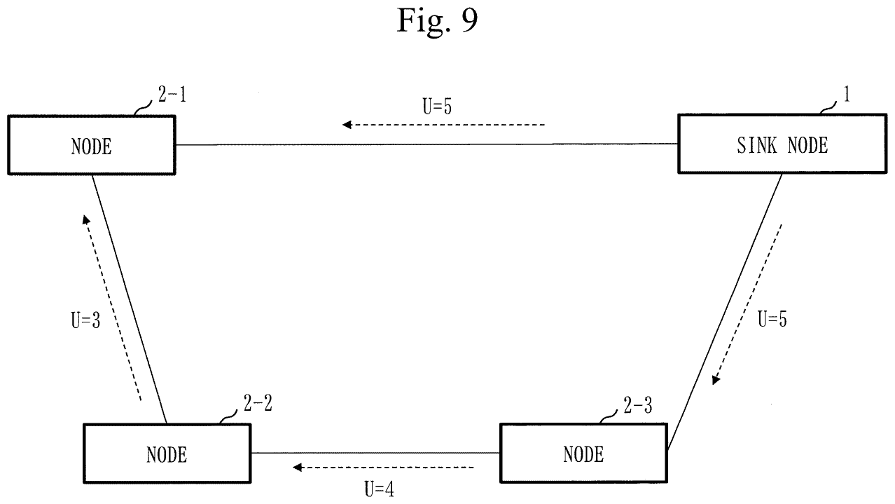

FIG. 9 is a diagram illustrating an example of transmission and reception of the transfer hop count signal according to Embodiment 1. FIG. 9 illustrates an example where data transmitted from the sink node 1 reaches the node 2-1 through two routes. Specifically, the first route (referred to as Route 1) is a route that leads directly from the sink node 1 to the node 2-1. The second route (referred to as Route 2) passes through each node in the order of the sink node 1, the node 2-3, the node 2-2, and the node 2-1. FIG. 9 illustrates an example where the initial value I is 5, and the update value U at the time point corresponding to each arrow is indicated near each arrow.

The update value U of the transfer hop count signal received by the node 2-1 through Route 1 is 5, so that the hop count from the sink node 1 to the node 2-1 is 5-5+1=1 based on [Formula 1]. The update value U indicated by the transfer hop count signal received by the node 2-1 through Route 2 is 3, so that the hop count from the sink node 1 to the node 2-1 is 5-3+1=3 based on [Formula 1].

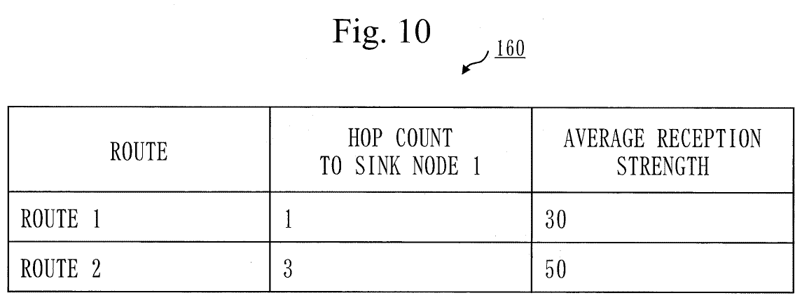

FIG. 10 is a diagram illustrating an example of the hop count information 160 according to Embodiment 1. The hop count information 160 is information associating a hop count from the node 2 to the sink node 1 with an average reception strength corresponding to the hop count. In the example shown in FIG. 10, it is indicated that the hop count corresponding to Route 1 is 1 and the average reception strength corresponding to Route 1 is 30. It is also indicated that the hop count corresponding to Route 2 is 3 and the average reception strength corresponding to Route 2 is 50.

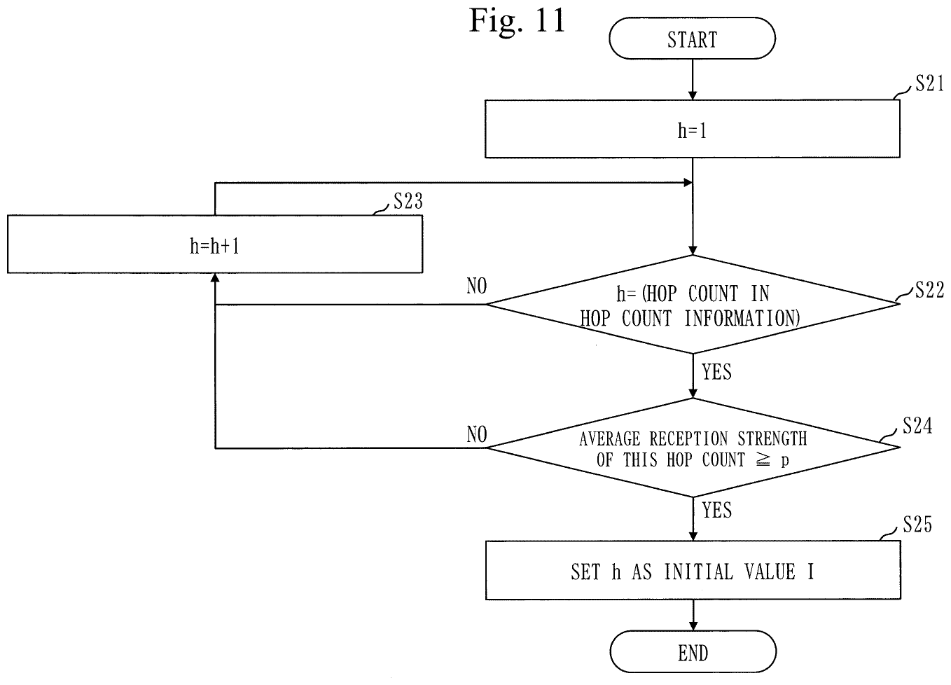

FIG. 11 is a flowchart illustrating an example of a procedure for setting the initial value I in the node 2. Using FIG. 11, the procedure for setting the initial value I will be described.

### (Step S21)

The communication control unit 22 sets 1 as the initial value of a variable h.

### (Step S22)

The communication control unit 22 determines whether the value of h matches any of the hop counts indicated by the hop count information 160 stored in the storage unit 23. If the value of h matches any of the hop counts indicated by the hop count information 160, the communication control unit 22 proceeds to step S24. In other cases, the communication control unit 22 proceeds to step S23.

### (Step S23)

The communication control unit 22 increments the value of h by one and repeats processing from step S22.

### (Step S24)

The communication control unit 22 determines whether the average reception strength corresponding to the hop count that is the same as the value of h is equal to or greater than a predetermined value of a variable p.

If the average reception strength of this hop count is less than the value of the variable p (NO in step S24), the communication control unit 22 increments the value of h by one (step S23) and repeats processing from step S22. If the average reception strength of this hop count is equal to or greater than the value of the variable p (YES in step S24), the communication control unit 22 proceeds to step S25.

### (Step S25)

The communication control unit 22 sets the value of h as the initial value I. That is, when subsequently acting as a transmission source of data, each node 2 uses h calculated by itself through the above procedure as the initial value I.

As a specific example, in the example shown in FIG. 10, when the value of the variable p is 40, Route 1 is not selected because the average reception strength corresponding to Route 1 is less than the value of the variable p although Route 1 is a route with the smallest hop count. On the other hand, the hop count of Route 2 (i.e., 3) is selected because the average reception strength corresponding to Route 2 is greater than the value of the variable p. Therefore, in the node 2-1, the initial value I for the transfer data 150 addressed to the sink node 1 is set to 3. When the node 2-1 is a source node, the initial value I corresponds to the hop count from the source node to the sink node 1.

By the above processing, it is possible to select an appropriate hop count from the hop counts indicated by hop count signals received by the node 2, and transmit the transfer data 150 in which the selected hop count is set as the initial value I.

### Description of Effects of Embodiment 1

As described above, in this embodiment, each node 2 holds the hop count information 160 indicating the hop count from each node 2 itself to the sink node 1, uses the held hop count information 160 to appropriately set the initial value I for the transfer data 150 addressed to the sink node 1, and then transmits the transfer data 150. This can prevent unnecessary transfer by other nodes 2 from occurring even when transmission occurs from a node with a relatively small hop count from the destination node. As a result, communication with relatively high efficiency can be realized.

Each node 2 sets the initial value I for the transfer data 150 addressed to the sink node 1 using the hop count from each node 2 to the sink node 1. This allows the initial value I to be set appropriately for transmission to the sink node 1, which makes up a large part of communication carried out in the communication system 5. As a result, the transfer efficiency of the communication system 5 as a whole can be improved.

Embodiment 1 has presented the methods to calculate the hop count using the sink node 1 as a basis and to determine, for each node 2, the initial value I for data addressed to the sink node 1. However, this embodiment is not limited to this example, and the hop count may be calculated and the initial value I may be set using any of the nodes 2 included in the communication system 5 as a basis.

### *** Other Configurations ***

### <Variation 1>

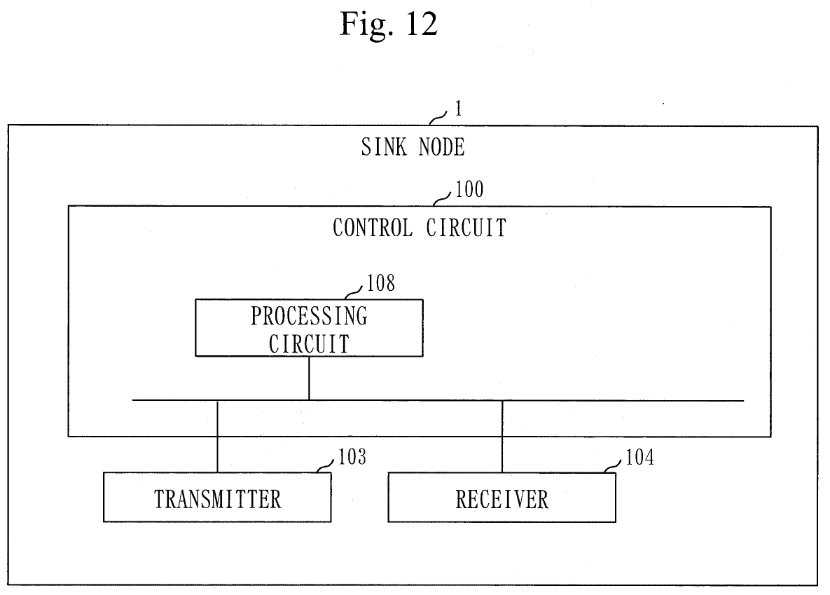

FIG. 12 illustrates an example of the hardware configuration of the sink node 1 according to this variation.

The sink node 1 includes a processing circuit 108 in place of the processor 101 or in place of the processor 101 and the memory 102.

The processing circuit 108 is hardware that realizes at least part of the units included in the sink node 1.

The processing circuit 108 may be dedicated hardware or may be a processor that executes programs stored in the memory 102.

When the processing circuit 108 is dedicated hardware, the processing circuit 108 is, as a specific example, a single circuit, a composite circuit, a programmed processor, a parallel-programmed processor, an application specific integrated circuit (ASIC), a field programmable gate array (FPGA), or a combination of these.

The sink node 1 may include a plurality of processing circuits as an alternative to the processing circuit 108. The plurality of processing circuits share the role of the processing circuit 108.

In the sink node 1, some functions may be realized by dedicated hardware, and the remaining functions may be realized by software or firmware.

As a specific example, the processing circuit 108 is realized by hardware, software, firmware, or a combination of these.

The processor 101, the memory 102, and the processing circuit 108 are collectively referred to as “processing circuitry”. That is, the functions of each functional component of the sink node 1 are realized by the processing circuitry.

The sink node 1 according to other embodiments may have substantially the same configuration as that of this variation.

### Embodiment 2

Differences from the embodiment described above will be mainly described below with reference to the drawings.

### *** Description of Configuration ***

The configurations according to this embodiment are substantially the same as the configurations according to Embodiment 1.

If a count of one or more nodes 2, among the plurality of nodes 2, that are present within a communication range of the target node and can transfer second transmission data when the second transmission data is transmitted from the target node to the sink node 1 is equal to or less than a reference adjacent node count, the communication control unit 22 of the target node increases the number of times to transmit the second transmission data by the target node and the number of times to transmit transfer data by the target node. The reference adjacent node count can be specified in any way.

### *** Description of Operation ***

Differences from Embodiment 1 will be mainly described below. In Embodiment 2, the procedure up to generation of the hop count information by each node 2 is substantially the same as that in Embodiment 1.

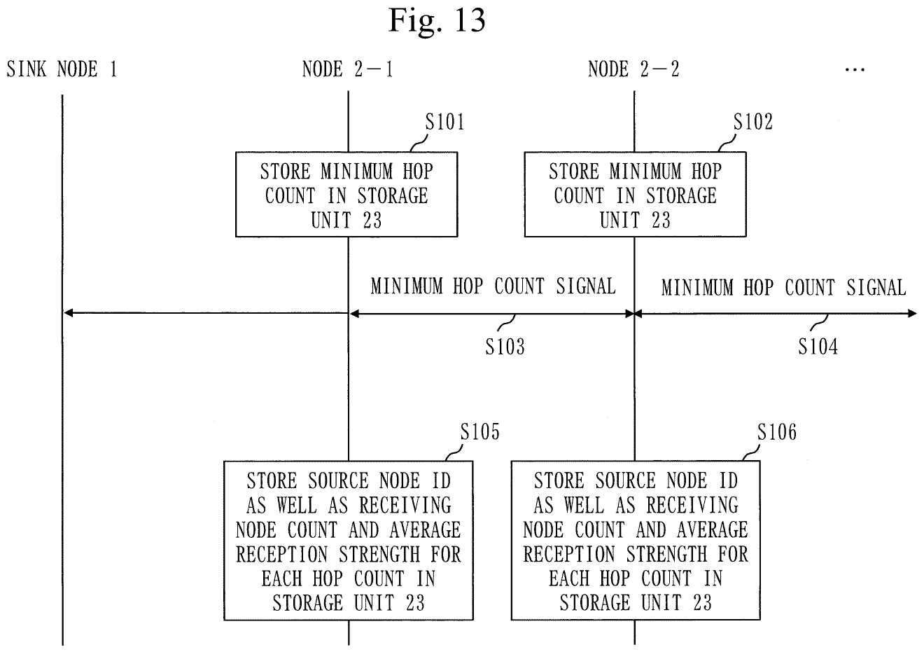

FIG. 13 is a sequence diagram illustrating an example of a procedure for setting the number of times to transmit in the node 2. Using FIG. 13, the procedure for setting the number of times to transmit will be described.

### (Step S101)

The node 2-1 stores data indicating the hop count calculated in the procedure for setting the initial value I according to Embodiment 1 in the storage unit 23.

Step S102 is substantially the same as step S101.

### (Step S103)

The node 2-1 transmits a minimum hop count signal that includes information indicating the minimum hop count from the sink node 1 to the node 2-1 to each adjacent node corresponding to the node 2-1. Each adjacent node corresponding to the target node is each node 2 with which the target node can communicate.

Step S104 is substantially the same as step S103.

### (Step S105)

Upon receiving the minimum hop count signal, the node 2-1 stores data indicating a source node ID, a receiving node count for each hop count, and an average reception strength for each hop count that are indicated by the received minimum hop count signal in the storage unit 23. The source node ID is substantially the same as the source node ID 151.

Step S106 is substantially the same as step S105.

Then, although not illustrated in the figure, each node 2 that has received the minimum hop count signal transferred from another node 2 performs the processing indicated in step S101, step S103, and step S105, like the node 2-1.

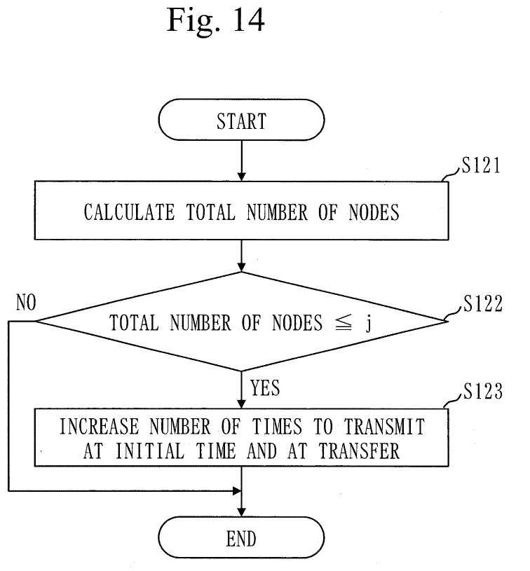

FIG. 14 is a flowchart illustrating an example of the procedure for setting the number of times to transmit in the target node, which is the node 2. Using FIG. 14, the procedure for setting the number of times to transmit will be described.

### (Step S121)

The communication control unit 22 counts first adjacent nodes corresponding to the target node with regard to the minimum hop count, and calculates the total number of first adjacent nodes. The first adjacent nodes corresponding to the target node are composed of each adjacent node whose minimum hop count is the same as the minimum hop count of the target node and each adjacent node whose minimum hop count is smaller by one than the minimum hop count of the target node. A first adjacent node is the node 2 that acts as a transfer node when the transfer data 150 is transmitted from the target node to the sink node 1. That is, a first adjacent node is the node 2 that is present within the communication range of the target node and can transfer second transmission data when the second transmission data is transmitted from the target node to the sink node 1.

Note that only each node 2 whose average reception strength exceeds a predetermined threshold may be counted in step S121. This makes it possible to calculate the number of first adjacent nodes that can communicate properly and are substantially valid.

### (Step S122)

The communication control unit 22 determines whether the total number of nodes calculated in step S121 is equal to or less than a predetermined value of a variable j.

If the total number of nodes exceeds the value of the variable j, the communication control unit 22 ends the processing. In other cases, the communication control unit 22 proceeds to step S123.

### (Step S123)

The communication control unit 22 increases each of the number of times to transmit at initial transmission and the number of times to transmit at transfer to a predetermined value.

The above processing makes it possible to appropriately increase the number of times to transmit only to each node 2 with a relatively small number of first adjacent nodes that act as transfer nodes when the transfer data 150 is transmitted to the sink node 1.

### Description of Effects of Embodiment 2

As described above, in this embodiment, the node 2 appropriately increases the number of times to transmit only to each node 2 with a relatively small number of first adjacent nodes. As a result, even if there are a small number of first adjacent nodes, data is more likely to be delivered between adjacent nodes, and thus communication with relatively high transfer efficiency can be realized.

### Embodiment 3

Differences from the embodiments described above will be mainly described below with reference to the drawings.

### *** Description of Configuration ***

The configurations according to this embodiment are substantially the same as the configurations according to Embodiment 1.

The communication control unit 22 of the target node performs control of the transfer function of the target node depending on the number of nodes 2 present within the communication range of the target node among the plurality of nodes 2 and the number of nodes 2 present within the communication range of each node 2 present in the communication range of the target node among the plurality of nodes 2. The communication control unit 22 of the target node may perform, as the control of the transfer function of the target node, one of disabling the transfer function of the target node and setting the number of times to transmit the transfer data 150 by the target node.

### *** Description of Operation ***

Differences from Embodiment 1 will be mainly described below.

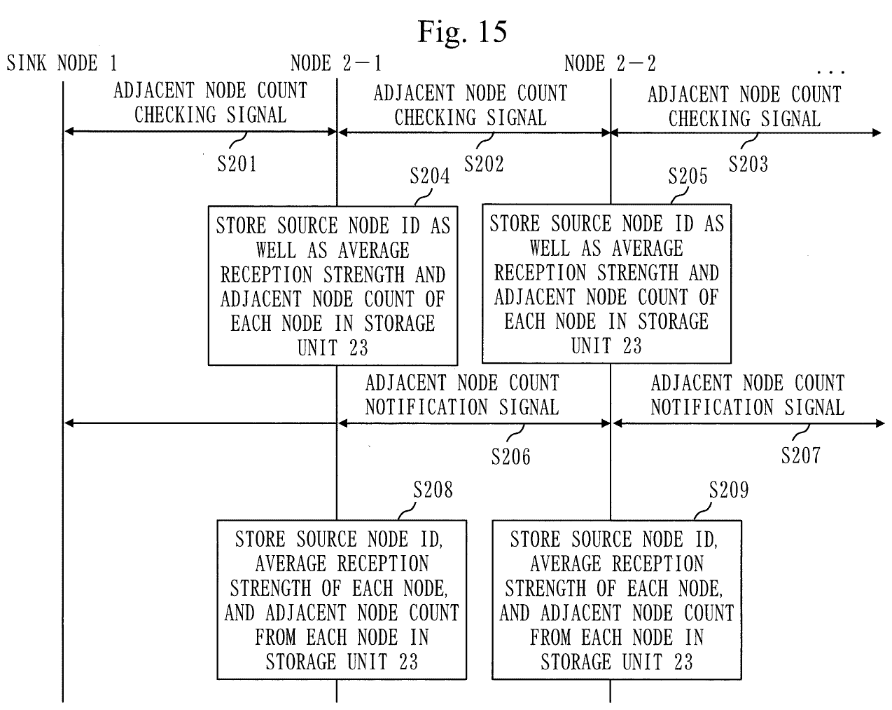

FIG. 15 is a sequence diagram illustrating an example of a procedure for setting the transfer function in the node 2. Using FIG. 15, the procedure for setting the transfer function will be described.

### (Step S201)

The sink node 1 transmits an adjacent node count checking signal to each adjacent node.

### (Step S202)

The node 2-1 transmits an adjacent node count checking signal to each adjacent node.

Step S203 is substantially the same as step S202.

### (Step S204)

Upon receiving each adjacent node count checking signal, the node 2-1 stores, in the storage unit 23, data indicating the source node ID and the average reception strength of each node 2 indicated by each adjacent node count checking signal as well as the number of adjacent nodes that have transmitted each adjacent node count checking signal received by the node 2-1. The source node ID is substantially the same as the source node ID 151.

Step S205 is substantially the same as step S204.

### (Step S206)

The node 2-1 transmits an adjacent node count notification signal that includes information indicating an adjacent node count corresponding to the node 2-1 to each adjacent node.

Step S207 is substantially the same as step S206.

### (Step S208)

Upon receiving the adjacent node count notification signal, the node 2-1 stores data indicating the source node ID, the average reception strength of each node 2, and the adjacent node count from each node 2 that are indicated by the received adjacent node count notification signal in the storage unit 23.

Step S209 is the substantially same as step S208.

Then, although not illustrated in the figure, each node 2 that has received the adjacent node count notification signal from another node 2 performs the processing indicated in step S204, step S206, and step S208, like the node 2-1.

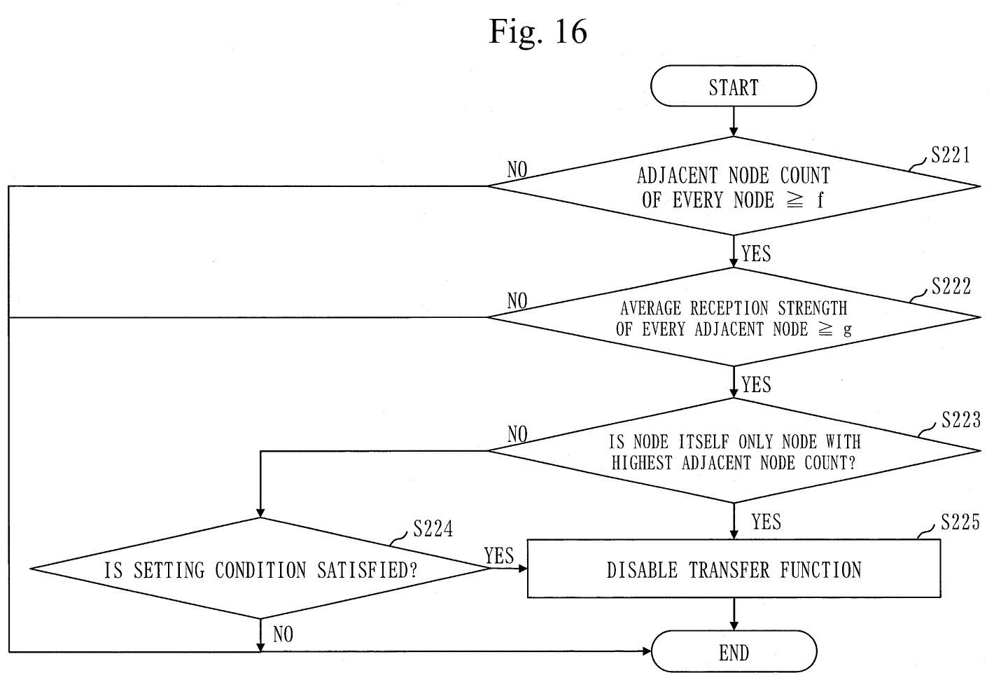

FIG. 16 is a flowchart illustrating an example of the procedure for setting the transfer function in the target node, which is the node 2. Using FIG. 16, the procedure for setting the transfer function will be described.

### (Step S221)

The communication control unit 22 determines whether or not every adjacent node count corresponding to each node 2 is equal to or greater than a predetermined value of a variable f.

If the adjacent node count corresponding to any node 2 is less than the value of the variable f, the communication control unit 22 ends the processing. In other cases, the communication control unit 22 proceeds to step S222.

### (Step S222)

The communication control unit 22 determines whether the average reception strength of every adjacent node of the target node is equal to or greater than a predetermined value of a variable g.

If the average reception strength of any adjacent node is less than the value of the variable g, the communication control unit 22 ends the processing. In other cases, the communication control unit 22 will proceed to step S223.

### (Step S223)

The communication control unit 22 determines whether the target node is the only node 2 with the largest adjacent node count among each adjacent node and the target node.

If the target node is the only node 2 with the largest adjacent node count, the communication control unit 22 proceeds to step S225. In other cases, the communication control unit 22 proceeds to step S224.

### (Step S224)

The communication control unit 22 determines whether or not there is any node 2 whose transfer function needs to be disabled based on a predetermined setting condition. As a specific example, the setting condition indicates selecting a certain number of nodes 2 in ascending order of the node ID values and disabling the transfer function of each selected node 2, selecting a certain number of node IDs randomly and disabling the transfer function of each selected node 2, or disabling the transfer function of each node 2 after a random time period has passed.

If the setting condition is satisfied, that is, if there is any node 2 whose transfer function needs to be disabled, the communication control unit 22 proceeds to step S225. In other cases, the communication control unit 22 ends the processing. Note that the communication control unit 22 enables the transfer function of each node 2 whose transfer function does not need to be disabled.

### (Step S225)

The communication control unit 22 disables the transfer function of the target node. In addition, if the communication control unit 22 determines that there is any node 2 whose transfer function needs to be disabled in step S224, it disables the transfer function of each node 2 whose transfer function needs to be disabled according to the setting condition.

A node whose transfer function has been disabled transmits a disabled transfer function notification signal to each adjacent node to notify that its transfer function has been disabled. Upon receiving the disabled transfer function notification signal, the node 2 erases data indicating the source node ID, the average reception strength of each node 2, and the adjacent node count corresponding to each node 2 that correspond to the received disabled transfer notification signal from the storage unit 23 of the node 2. Each node 2, except for the node 2 whose transfer function has been disabled, repeats the processing from transmission and reception of the adjacent node count checking signal.

Through the above processing, the node 2 can find out the adjacent node count corresponding to each adjacent node and then enable or disable the transfer function.

When the transfer function is to be disabled, the target node may change the number of times to transmit by the target node at transfer to a predetermined value, instead of disabling the transfer function.

### Description of Effects of Embodiment 3

As described above, in this embodiment, each node 2 finds out the adjacent node count corresponding to each adjacent node and then enables or disables the transfer function of each node 2. As a result, even when adjacent nodes are densely located around each node 2, it is possible to reduce the number of occurrences of transfer before the transfer data 150 reaches the destination node. Therefore, communication with relatively high transfer efficiency can be realized.

### Embodiment 4

Differences from the embodiments described above will be mainly described below with reference to the drawings.

### *** Description of Configuration ***

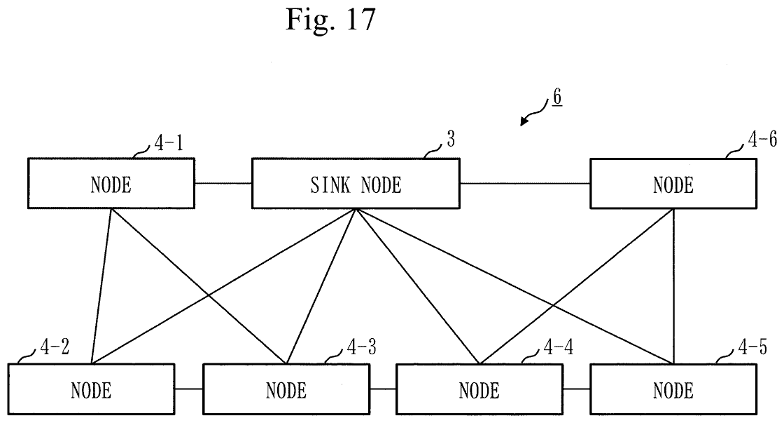

FIG. 17 is a diagram illustrating an example of the configuration of a communication system 6 according to Embodiment 4. The communication system 6 includes a sink node 3, which is an example of a sink node, and a plurality of nodes 4. In FIG. 17, the communication system 6 includes the sink node 3 and nodes 4-1 to 4-6, which are an example of the plurality of nodes 4 in proximity. The communication system 6 can construct a multi-hop wireless communication network.

In FIG. 17, one sink node and six nodes 4 are illustrated, but the number of sink nodes 3 and the number of nodes 4 are not limited to the examples shown in FIG. 17. Hereafter, when each of the plurality of nodes 4 is indicated without distinguishing them individually, it is referred to as the “node 4”. The sink node 3 and the node 4 may be collectively referred to as the “node”.

The configuration of the sink node 3 is substantially the same as the configuration of the sink node 1.

The configuration of the node 4 is substantially the same as the configuration of the node 2.

If there is a problem node among each node 4 present within the communication range of the sink node 3 among the plurality of nodes 4, the communication control unit 12 of the sink node 3 selects a node 4, as a selected node, from each node 4 present within the communication range of the problem node among each node 4 present within the communication range of the sink node 3, based on the reception strength corresponding to communication between the problem node and each node 4 present in the communication range of the problem node. The problem node is the node 4 that cannot communicate properly with the sink node 3.

The communication control unit 22 of the selected node controls the transfer function of the selected node so that data transmitted by the problem node to the sink node 3 can be transferred.

### *** Description of Operation ***

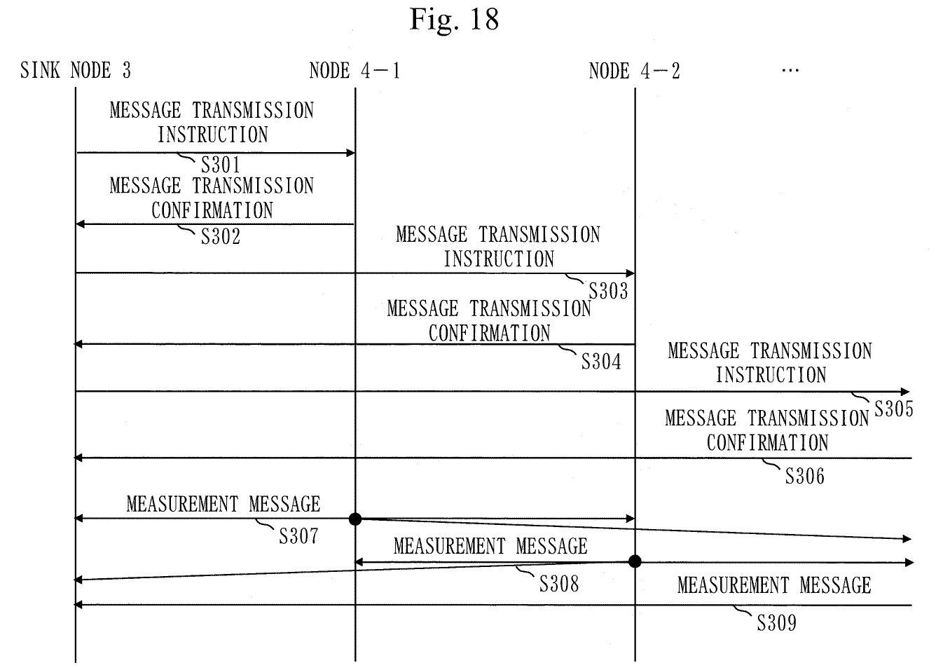

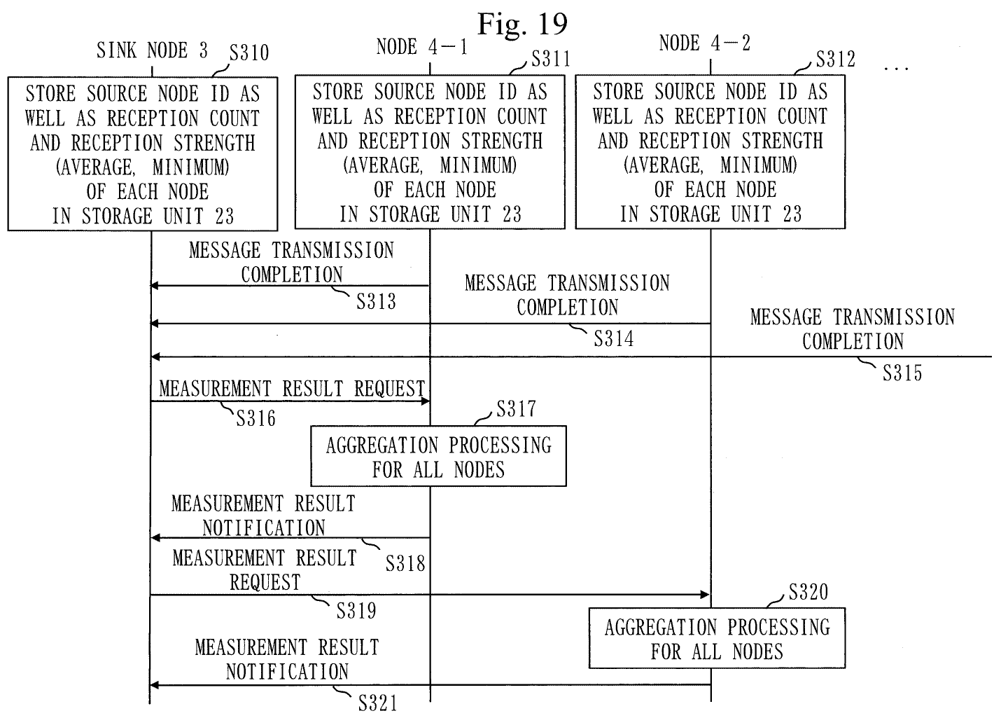

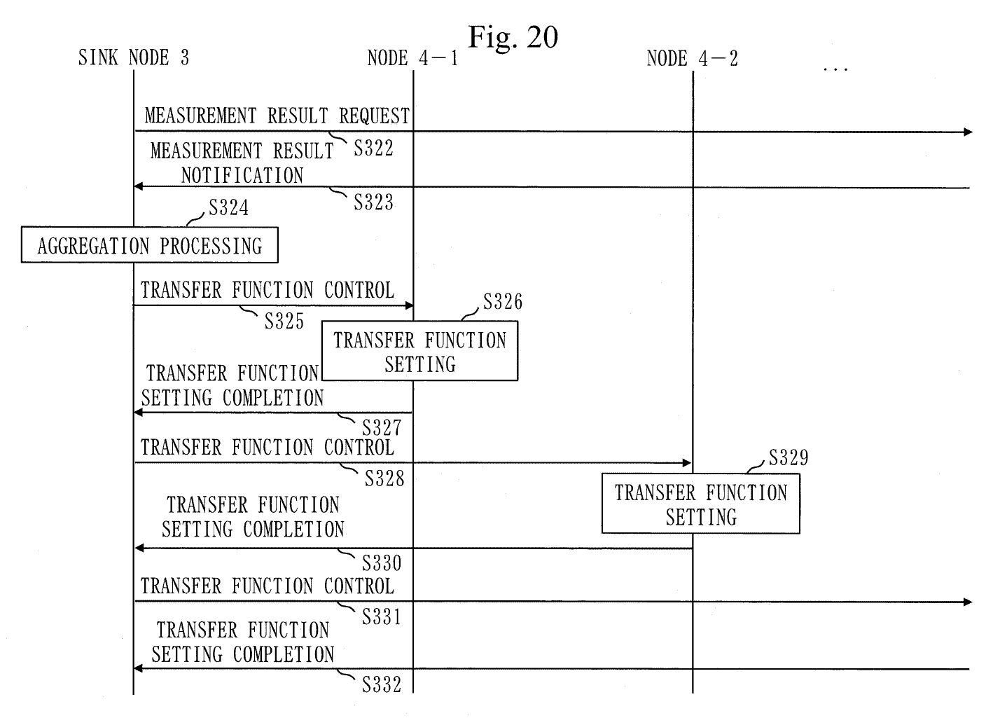

FIGS. 18 to 20 are sequence diagrams illustrating an example of a procedure for setting the transfer function in the node 4. Using FIGS. 18 to 20, the procedure for setting the transfer function will be described. Note that each node 4 involved in this example is the node 4 present in the communication range of the sink node 3.

### (Step S301)

The sink node 3 transmits a message transmission instruction a certain number of times to each node 4.

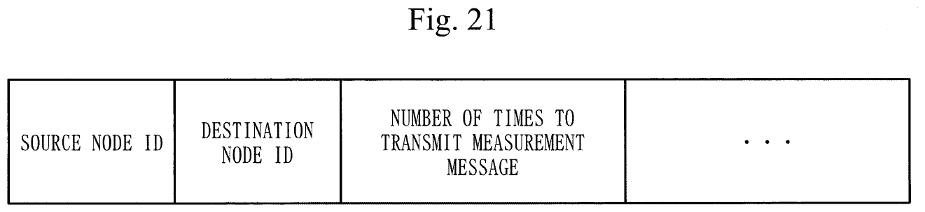

FIG. 21 is a diagram illustrating a data structure of the message transmission instruction. The message transmission instruction is data that includes information indicating a source node ID, a destination node ID, and the number of times to transmit a measurement message.

The source node ID is substantially the same as the source node ID 151.

The destination node ID is substantially the same as the destination node ID 152.

The number of times to transmit the measurement message is the number of times to transmit the measurement message to each adjacent node.

Step S303 and step S305 are substantially the same as step S301.

### (Step S302)

Upon receiving the message transmission instruction, the node 4-1 transmits a message transmission confirmation indicating that the message transmission instruction has been received to the sink node 3.

Step S304 and step S306 are substantially the same as step S302.

### (Step S307)

The node 4-1 repeatedly transmits the measurement message to each adjacent node the number of times indicated by the number of times to transmit the measurement message indicated by the received message transmission instruction.

Step S308 and step S309 are substantially the same as step S307.

(Step S310 to step S312)

Upon receiving the measurement message from another node 4, the sink node 3 and each node 4 store data indicating a source node ID, a reception count of each node, an average reception strength of each node, and a minimum reception strength of each node that are indicated by the received measurement message in the storage unit 13 and the storage unit 23, respectively.

Note that the measurement message may also include data indicating a maximum reception strength.

(Step S313 to step S315)

Each node 4 transmits data indicating that transmission of the measurement message has been completed to the sink node 3.

### (Step S316)

The sink node 3 transmits a measurement result request to the node 4-1.

Step S319 and step S322 are substantially the same as step S316.

### (Step S317)

When the node 4-1 receives the measurement result request, the communication control unit 22 of the node 4-1 aggregates measurement message reception results from each node 4.

Step S320 is substantially the same as step S317.

### (Step S318)

After aggregating the measurement message reception results, the node 4-1 transmits a measurement result notification indicating the aggregated reception results to the sink node 3.

Step S321 and step S323 are substantially the same as step S318.

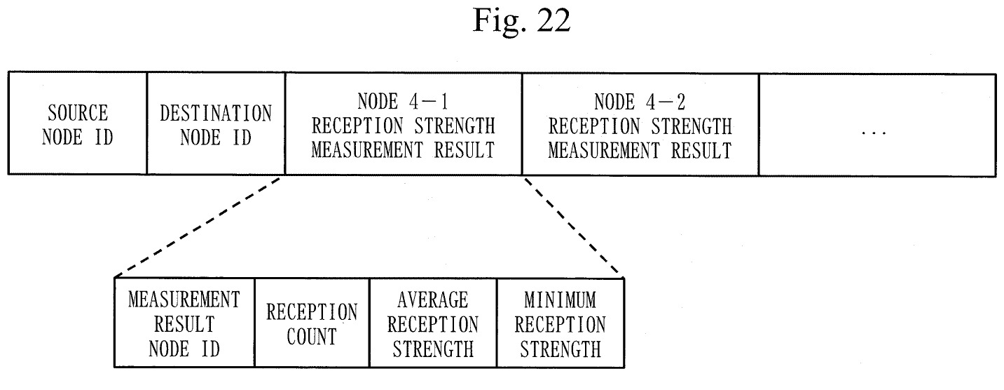

FIG. 22 is a diagram illustrating a data structure of the measurement result notification. The measurement result notification is data indicating a source node ID, a destination node ID, and a reception strength measurement result for each node 4. The source node ID is substantially the same as the source node ID 151. The destination node ID is substantially the same as the destination node ID 152. The data indicating the reception strength measurement result is data indicating a measurement result node ID, a reception count, an average reception strength, and a minimum reception strength. The data indicating the reception strength measurement result may include data indicating a maximum reception strength. The measurement result node ID is the source node ID indicated by the measurement message received from another node 4. The reception strength measurement result for each node 4 is data obtained by receiving the measurement message from another node 4.

### (Step S324)

After receiving the measurement result notification from each node 4, the sink node 3 carries out aggregation processing.

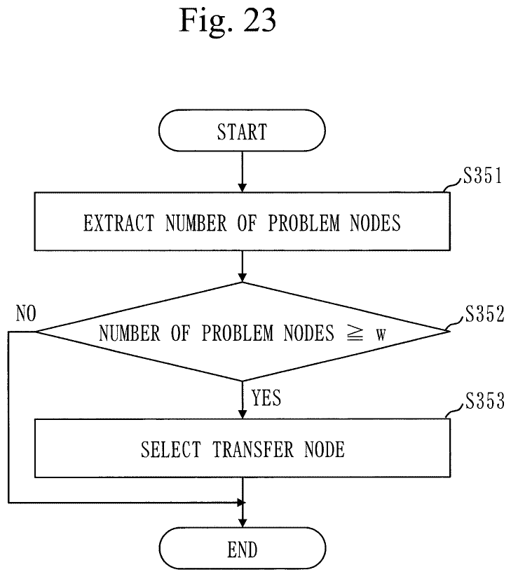

FIG. 23 is a flowchart illustrating specific processing of this step. Using FIG. 23, the processing of this step will be described.

### (Step S351)

The communication control unit 12 aggregates the measurement result notifications from each node 4, and calculates a total value of the number of problem nodes included in all the nodes 4 (hereafter, also referred to as a problem node count) based on the aggregated results. A problem node is at least one of the node 4 whose average reception strength or minimum reception strength is equal to or less than a specified value, the node 4 that cannot directly communicate with the sink node 3, and the node 4 whose reception count is equal to or less than a specified value.

### (Step S352)

The communication control unit 12 determines whether the problem node count is equal to or greater than a predetermined value of a variable w.

If the problem node count is equal to or greater than the value of the variable w, the communication control unit 12 proceeds to step S353. In other cases, the communication control unit 12 ends the processing.

### (Step S353)

The communication control unit 12 selects a transfer node. Specifically, using the measurement results collected from each node 4, the communication control unit 12 selects one or more nodes 4 with the highest average reception strength in relation to the problem node among each node 4 whose reception count from the sink node 3 is equal to or greater than a specified value, as a target or targets whose transfer function is to be enabled.

(Step S325, step S328, and step S331)

The sink node 3 transmits transfer function control to each node 4. The transfer function control indicates an instruction to enable or disable the transfer function.

### (Step S326)

When the node 4-1 receives the transfer function control, the communication control unit 22 of the node 4-1 enables or disables the transfer function according to the instruction indicated by the received transfer function control.

Step S329 is substantially the same as step S326.

### (Step S327)

After setting the transfer function, the node 4-1 transmits transfer function setting completion indicating completion of setting the transfer function according to the received transfer function control to the sink node 3.

Step S330 and step S332 are substantially the same as step S327.

Then, although description is omitted, in each node 4 that has received the message transmission instruction from the sink node 3, processing that is substantially the same as the processing in the node 4-1 is performed.

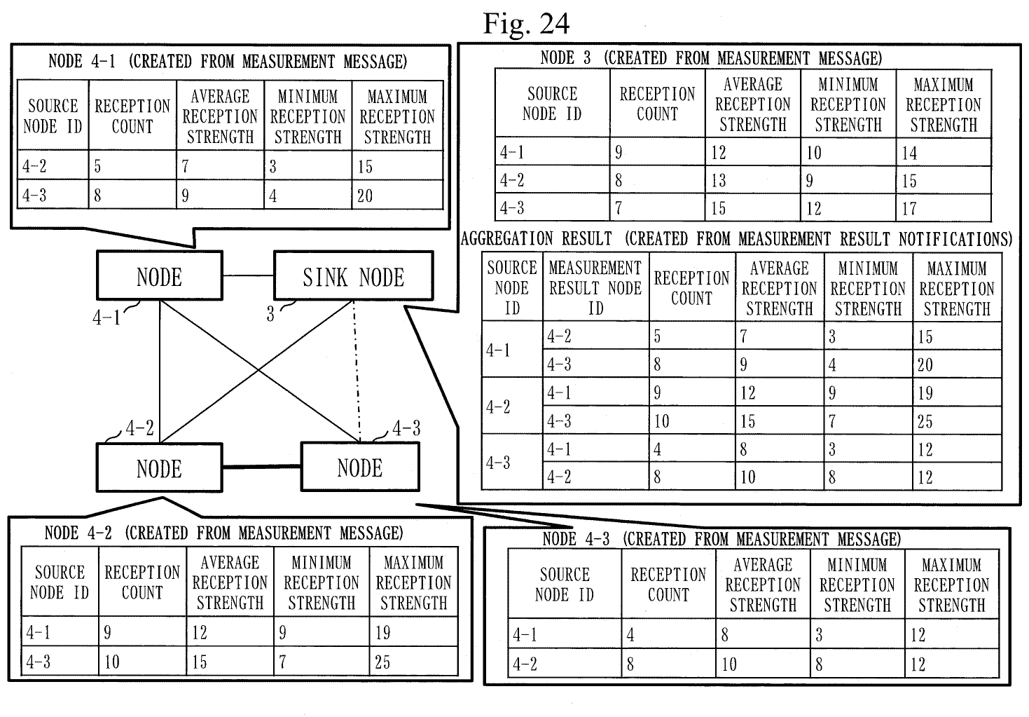

FIG. 24 is a diagram describing an example of selection of a transfer node in the sink node 3. In this example, the nodes 4-1, 4-2, and 4-3 are present within the communication range of the sink node 3.

In this example, among the nodes 4 that have received the measurement message of the sink node 3, the node 4 whose reception count is equal to or less than a reception count threshold of 7 is treated as a problem node. In this example, the node 4-3 is the problem node.

The sink node 3 selects, as a target whose transfer function is to be enabled, the node 4 corresponding to a source node ID with a reception count equal to or greater than a specified value and the highest average reception strength corresponding to communication with the problem node among source node IDs whose measurement result notification includes the node ID of the problem node as a measurement result node ID. In this example, the node ID of the problem node is included in the measurement result node IDs of each of the node 401 and the node 402. The reception counts corresponding to the node 4-1 and the node 4-2 are equal to or greater than the specified value. As to the average reception strength corresponding to communication with the problem node, the average reception strength corresponding to the node 4-2 is the highest. That is, the node 4-2 is selected as the target whose transfer function is to be enabled in this example.

Through the above processing, the sink node 3 can appropriately set the transfer function for each node 4 present within the communication range of the sink node 3.

Note that when transmitting the transfer function control, the sink node 3 may instruct control to set the number of times to transmit at transfer to a predetermined value, instead of instructing control to disable the transfer function.

### Description of Effects of Embodiment 4

As described above, in this embodiment, the sink node 3 enables the transfer function of the node 4 that can transfer data transmitted by the problem node, with regard to each node 4 present within the communication range of the sink node 3. Therefore, according to this embodiment, even in a configuration where the nodes 4 are densely located in an area surrounding the sink node 3, it is possible to set the transfer function for an appropriate node 4. In addition, according to this embodiment, even when the nodes 4 are densely located within the communication range of the sink node 3, it is possible to reduce the number of occurrences of transfer until the transfer data 150 reaches the destination node. Therefore, communication with relatively high transfer efficiency can be realized.

In addition, even in a case where there is no problem node around the sink node 3, if the nodes 4 with the enabled transfer function are densely located around the sink node 3, the amount of data per unit time can increase depending on the number of nodes, a transmission period, and so on. Therefore, in this case, the data arrival rate may decrease due to an increased probability of data collision. On the other hand, according to this embodiment, by appropriately setting the transfer function for each node 4, the number of occurrences of transfer can be reduced and, furthermore, the data arrival rate to the sink node 3 can be improved.

### Other Embodiments

The embodiments described above can be freely combined, or any component of each embodiment can be modified. Alternatively, any component in each embodiment can be omitted.

The embodiments are not limited to those indicated in Embodiments 1 to 4, and various changes can be made as necessary. The procedures described using flowcharts or the like may be appropriately changed.

### REFERENCE SIGNS LIST

1, 3: sink node; 2, 4: node; 5, 6: communication system; 11, 21: transmission and reception unit; 12, 22: communication control unit; 13, 23: storage unit; 100: control circuit; 101: processor; 102: memory; 103: transmitter; 104: receiver; 108: processing circuit; 150: transfer data; 151: source node ID; 152: destination node ID; 160: hop count information.

1. A communication system comprising a sink node and a plurality of nodes, the communication system being capable of constructing a multi-hop wireless communication network,
wherein a target node, which is each node of the plurality of nodes, includes
processing circuitry to:
update a first update value to an updated first update value upon receiving transfer data that is transmitted from a source node included in the plurality of nodes to the sink node and indicates an update value corresponding to a hop count from the source node to the target node, the first update value being the update value indicated by the received transfer data; and
transmit transfer data in which the first update value has been updated to the updated first update value to surroundings of the target node when the updated first update value has not reached a transfer end value,
wherein a difference between the first update value and the updated first update value corresponds to one hop,
wherein an initial value of the update value indicated by the transfer data received by the target node is a value corresponding to a hop count from the source node to the sink node, and
wherein a route for transmitting the transfer data received by the target node is not specified.

2. The communication system according to claim 1,
wherein when the target node receives a transfer hop count signal that is transmitted from the sink node and indicates a second update value, which is an update value corresponding to a hop count from the sink node to the target node, and an initial value of the second update value, the processing circuitry of the target node calculates a hop count from the target node to the sink node based on the second update value and the initial value that are indicated by the received transfer hop count signal, stores the calculated hop count as a minimum hop count from the target node to the sink node, and updates the second update value indicated by the received transfer hop count signal to an updated second update value,
wherein a difference between the second update value and the updated second update value corresponds to one hop,
wherein the minimum hop count is used as an initial value of an update value indicated by first transmission data when the target node transmits the first transmission data to the sink node, and
wherein when the updated second update value has not reached the transfer end value, the processing circuitry of the target node transmits a transfer hop count signal in which the second update value has been updated to the updated second update value to surroundings of the target node.

3. The communication system according to claim 2,
wherein when the transfer hop count signal has arrived at the target node through a plurality of routes, the processing circuitry of the target node stores, as the minimum hop count, a hop count corresponding to a shortest route among each route whose corresponding reception strength is equal to or greater than a first reference reception strength among the plurality of routes.

4. The communication system according to claim 1,
wherein when a count of one or more nodes, among the plurality of nodes, that are present within a communication range of the target node and can transfer second transmission data when the second transmission data is transmitted from the target node to the sink node is equal to or less than a reference adjacent node count, the processing circuitry of the target node increases the number of times to transmit the second transmission data by the target node and the number of times to transmit the transfer data by the target node.

5. The communication system according to claim 1,
wherein the processing circuitry of the target node performs control of a transfer function of the target node, depending on a count of nodes, among the plurality of nodes, that are present within a communication range of the target node and a count of nodes, among the plurality of nodes, that are present within a communication range of each node present within the communication range of the target node.

6. The communication system according to claim 5,
wherein the processing circuitry of the target node performs, as the control of the transfer function of the target node, one of disabling the transfer function of the target node and setting the number of times to transmit the transfer data by the target node.

7. The communication system according to claim 1,
wherein the sink node includes
processing circuitry to select a node as a selected node when there is a problem node that cannot properly communicate with the sink node among each node present within a communication range of the sink node among the plurality of nodes, the selected node being selected from each node present within a communication range of the problem node among each node present within the communication range of the sink node, based on a reception strength corresponding to communication between each node present within the communication range of the problem node and the problem node, and
wherein processing circuitry of the selected node controls a transfer function of the selected node so as to enable transfer of data transmitted by the problem node to the sink node.

8. The communication system according to claim 1,
wherein the processing circuitry of the target node treats only a node whose corresponding reception strength is equal to or greater than a second reference reception strength among the plurality of nodes as a valid node.

9. A communication method that is executed in a communication system that includes a sink node and a plurality of nodes and is capable of constructing a multi-hop wireless communication network, the communication method comprising:
updating a first update value to an updated first update value upon receiving transfer data that is transmitted from a source node included in the plurality of nodes to the sink node and indicates an update value corresponding to a hop count from the source node to the target node, the first update value being the update value indicated by the received transfer data, by a computer included in a target node, which is each node of the plurality of nodes; and
transmitting transfer data in which the first update value has been updated to the updated first update value to surroundings of the target node when the updated first update value has not reached a transfer end value, by the computer,
wherein a difference between the first update value and the updated first update value corresponds to one hop,
wherein an initial value of the update value indicated by the transfer data received by the target node is a value corresponding to a hop count from the source node to the sink node, and
wherein a route for transmitting the transfer data received by the target node is not specified.

10. A non-transitory computer readable medium storing a communication program that is executed in a communication system that includes a sink node and a plurality of nodes and is capable of constructing a multi-hop wireless communication network by a computer included in a target node, which is each node of the plurality of nodes, the communication program causing the computer to execute:
a communication control process of updating a first update value to an updated first update value when the target node receives transfer data that is transmitted from a source node included in the plurality of nodes to the sink node and indicates an update value corresponding to a hop count from the source node to the target node, the first update value being the update value indicated by the received transfer data; and
a transmission and reception process of transmitting transfer data in which the first update value has been updated to the updated first update value to surroundings of the target node when the updated first update value has not reached a transfer end value,
wherein a difference between the first update value and the updated first update value corresponds to one hop,
wherein an initial value of the update value indicated by the transfer data received by the target node is a value corresponding to a hop count from the source node to the sink node, and
wherein a route for transmitting the transfer data received by the target node is not specified.
